(19) United States
(12) Patent Application Publication
(10) Pub. No.: US 2010/0188838 A1
(43) Pub. Date: Jul. 29, 2010

(54) ILLUMINATING APPARATUS

(75) Inventors: Jun Yajima, Imabari-shi (JP); Hiromitsu Shiraishi, Imabari-shi (JP); Masamitsu Nagano, Imabari-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: HARISON TOSHIBA LIGHTING CORP., EHIME (JP)

(21) Appl. No.: 12/677,403

(22) PCT Filed: Jun. 25, 2008
(86) PCT No.: PCT/JP08/61555

§ 371 Date: Apr. 2, 2010

(30) Foreign Application Priority Data
Sep. 10, 2007 (JP) 2007-234636
Sep. 10, 2007 (JP) 2007-234637

(51) Int. Cl. F21V 9/16; F21V 7/00; F21V 29/00; F21V 9/00

(52) U.S. Cl. 362/84; 362/296.01; 362/294; 362/231

(57) ABSTRACT

A peak of the radiation directivity of light emitted by each of LEDs is directed to a reflecting surface, and the light emitted by the LEDs is indirectly incident on an outer lens after reflection by the reflecting surface. Thus, problems, such as a local increase in brightness of a light emitting surface over areas corresponding to light emitting portions of the LEDs, are prevented. In addition, most of the light emitted by the LEDs is indirectly incident on the outer lens via the reflecting surface, so that dispersion of blue light and yellow light, which constitute the white light, by the outer lens is prevented. Thus, illumination light highly uniform in amount and color can be provided.

### TECHNICAL FIELD

The present invention relates to an illuminating apparatus that incorporates a light emitting element, such as a light emitting diode, as a light source.

### BACKGROUND ART

A vehicle, such as a passenger car, has a vehicle interior lamp (illuminating apparatus), such as a room lamp and a map lamp, attached to the interior ceiling. Many of the vehicle interior lamps guide light from a light source, such as a light bulb, directly or indirectly to an outer lens to provide planar light emission from the outer surface of the outer lens, thereby producing desired illumination light. For example, according to a technique disclosed in Japanese Patent Application Laid-Open Publication No. 8-16927, a lens main body (outer lens) is formed by a light guide plate. Light from a light bulb, namely a light source, is directly incident on the outer lens, so that a region of the outer lens close to the light source serves as a direct illuminating part (a close-to-light-source region), and a region of the outer lens far from the light source (a far-from-light-source region) serves as an indirect illuminating part. According to the technique, the light incident on the close-to-light-source region can directly pass through the lens main body to provide spot illumination. On the other hand, the light incident on the far-from-light-source region is guided while being reflected through the lens main body toward the distal side thereof. The guided light is reflected by punctures on the way to transmit and exit the lens main body, thereby providing uniform illumination.

A light emitting diode (LED) is advantageous over the light bulb in that the LED has lower power consumption and longer life. In recent years, high-power LEDs have been developed, and the LEDs or other light emitting elements are expected as a light source of various relatively small illuminating apparatuses. For example, registered Japanese Utility Model No. 3129847 is directed to an illuminating apparatus incorporating LEDs as a light source, which is mounted with a plurality of LEDs disposed so as to face a lamp cover (outer lens).

However, the light emitting element, such as LED, is a point light source having a smaller light emitting part compared to a conventional light source, such as a light bulb. Therefore, if LEDs are disposed to directly face the outer lens as disclosed in registered Japanese Utility Model No. 3129847 described above, the illuminating apparatus will be impaired in appearance. For example, the brightness of the light emitting surface on the outer lens can be locally higher over the regions directly opposite to the LEDs (that is, glare or the like occurs).

Since the LED is a point light source having a smaller light emitting part compared to a conventional light source, such as a light bulb, particularly in the case where the light from the LED directly passes through the outer lens, the brightness (amount of light emission) on the light emitting surface of the outer lens can be made uniform only to a limited extent, and the appearance can be impaired. For example, the brightness of the light emitting surface of the outer lens can be extremely higher over the region directly opposite to the LED compared to the other region.

If a light guide plate or the like is interposed between the LED and the outer lens to disperse the emission light from the LED in order to solve the above problem, this can lead to another problem that the structure is complicated, or the weight increases, for example.

A typical white LED widely used as a light source is configured as a blue LED provided together with a yellow phosphor. In particular, in the case where light from the white LED of this type is incident on an outer lens functioning as a light guide plate, the blue light and the yellow light can be dispersed, and thus, the color of the light emitting surface of the outer lens can be nonuniform.

An object of the present invention is to provide an illuminating apparatus that can provide uniform illumination light with a simple configuration.

### DISCLOSURE OF INVENTION

### Means for Solving the Problem

An illuminating apparatus according to the present invention includes: an outer lens having an outer surface forming a light emitting surface; a reflecting member having a reflecting surface facing an inner surface of the outer lens; and a light emitting diode arranged in such a manner that a peak of a radiation directivity of emitted light is directed to the reflecting surface, and the reflecting surface reflects the emitted light from the light emitting diode to guide the light to the outer lens.

### BRIEF DESCRIPTION OF THE DRAWINGS

FIG. 1 is an exploded perspective view showing parts of a room lamp according to a first embodiment of the present invention;

FIG. 2 is a perspective view showing a switch provided with light emitting diodes according to the first embodiment of the present invention;

FIG. 3 is a plan view of the room lamp according to the first embodiment of the present invention;

FIG. 4 is a cross-sectional view of parts of the room lamp according to the first embodiment of the present invention taken along the line IV-IV in FIG. 3;

FIG. 5 is a cross-sectional view of parts of a modification of the room lamp according to the first embodiment of the present invention shown in FIG. 4;

FIG. 6 is a diagram showing a relative light emission intensity of the light emitting diode according to the first embodiment of the present invention;

FIG. 7 is a plan view of a map lamp according to the first embodiment of the present invention;

FIG. 8 is a cross-sectional view of parts of the map lamp according to the first embodiment of the present invention taken along the line IIX-IIX in FIG. 7;

FIG. 9 is an exploded perspective view showing parts of a room lamp according to a second embodiment of the present invention;

FIG. 10 is a plan view of the room lamp according to the second embodiment of the present invention;

FIG. 11 is a cross-sectional view of parts of the room lamp according to the second embodiment of the present invention taken along the line A-A in FIG. 10;

FIG. 12 is a cross-sectional view of parts of a modification of the room lamp according to the second embodiment of the present invention taken along the line A-A in FIG. 9;

FIG. 13 is a cross-sectional view of parts of a modification of the room lamp according to the second embodiment of the present invention taken along the line A-A in FIG. 9;

FIG. 14 is a cross-sectional view of parts of a modification of the room lamp according to the second embodiment of the present invention taken along the line A-A in FIG. 9;

FIG. 15 is a cross-sectional view of parts of a modification of the room lamp according to the second embodiment of the present invention taken along the line A-A in FIG. 9;

FIG. 16 is an exploded perspective view showing a relationship between a switch mechanism and a light source unit of the room lamp according to the second embodiment of the present invention shown in FIG. 15;

FIG. 17 is a cross-sectional view of parts of a modification of the room lamp according to the second embodiment of the present invention taken along the line B-B in FIG. 9;

FIG. 18A is an enlarged cross-sectional view showing a modification of an outer lens according to the second embodiment of the present invention;

FIG. 18B is a plan view showing an inner surface of the outer lens according to the second embodiment of the present invention in an enlarged manner; and

FIG. 18C is a plan view showing an inner surface of the outer lens according to the second embodiment of the present invention in an enlarged manner.

### BEST MODE FOR CARRYING OUT THE INVENTION

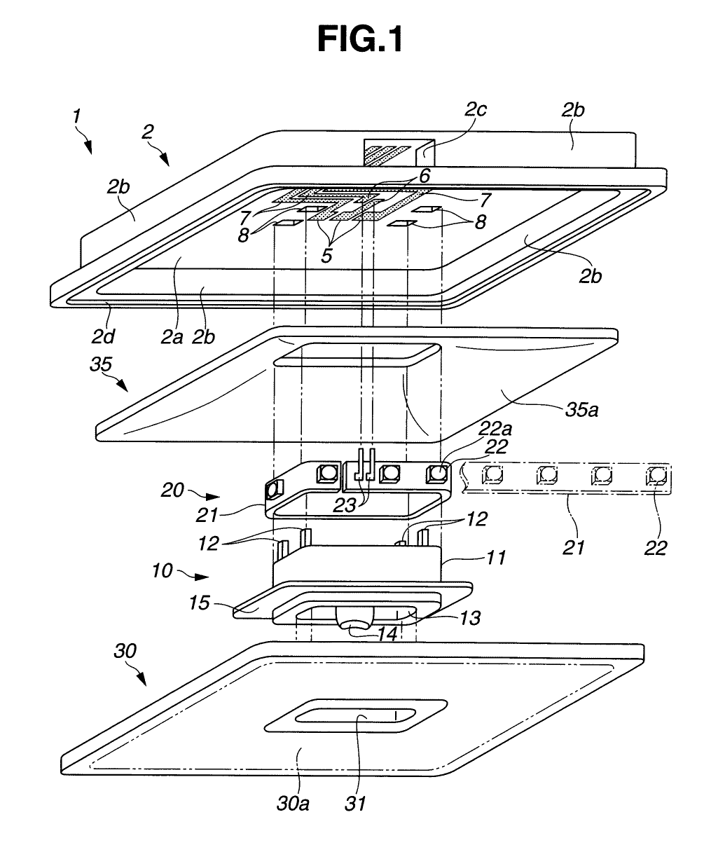

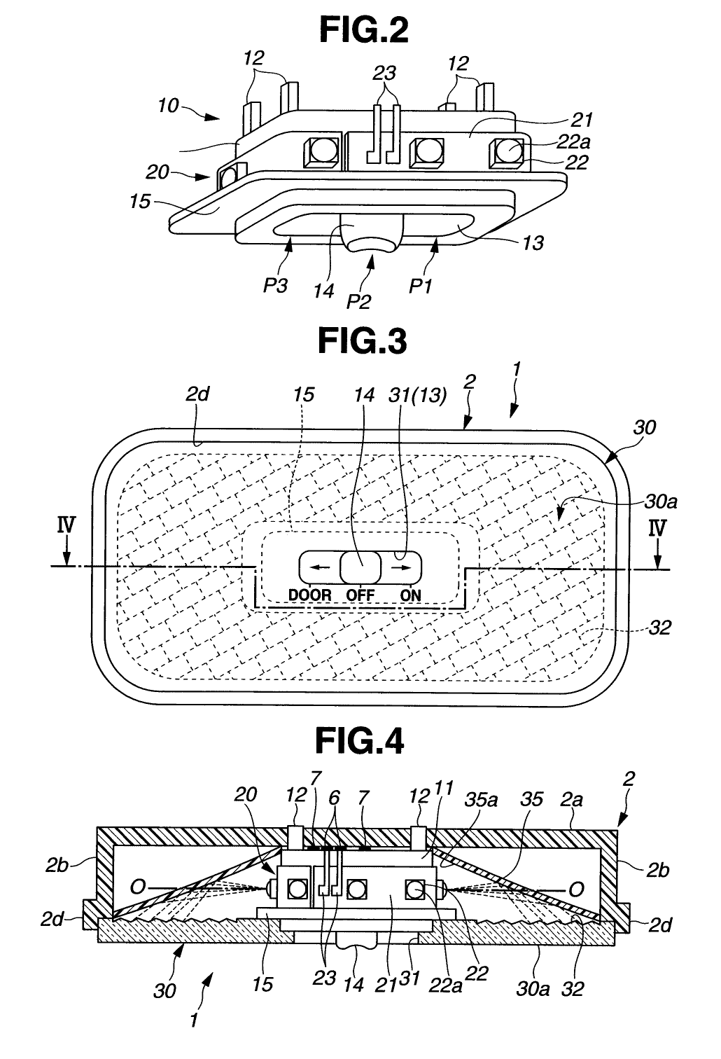

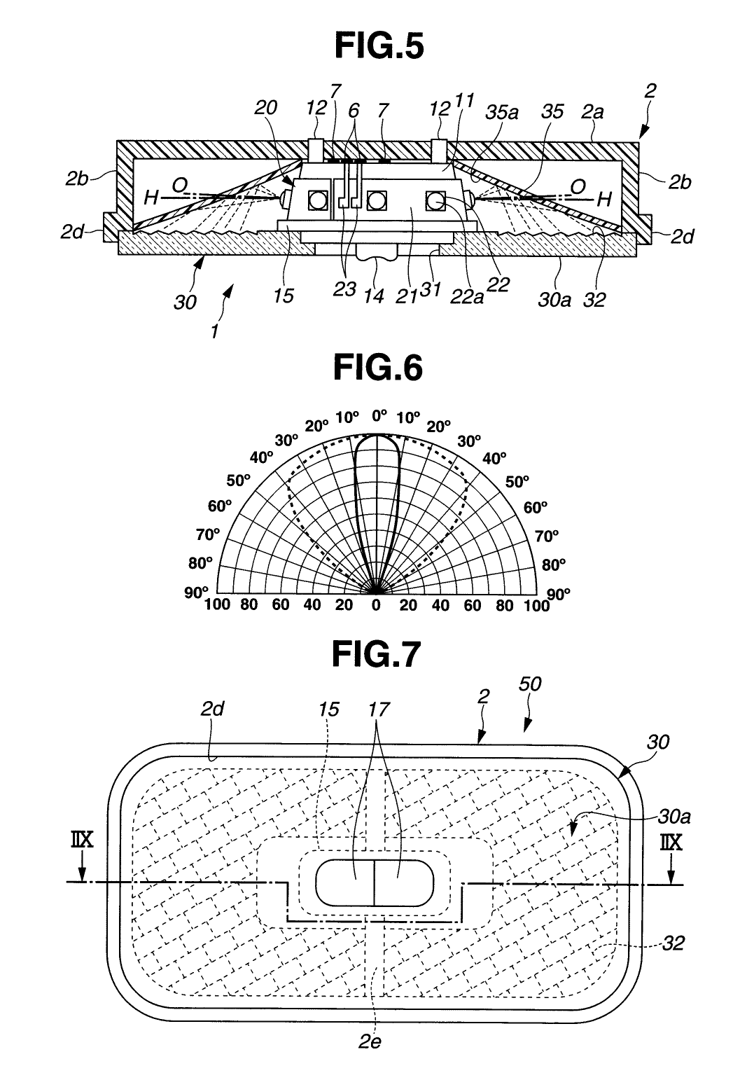

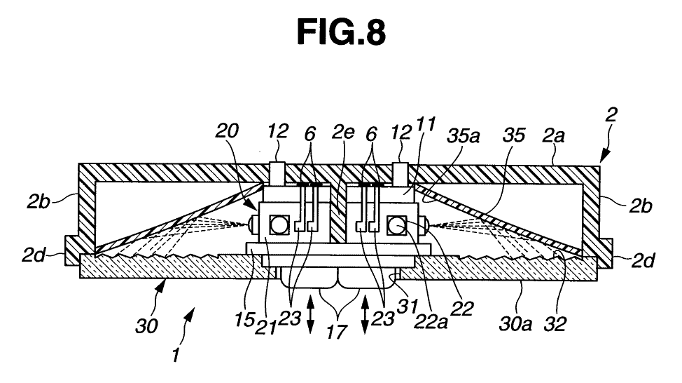

In the following, embodiments of the present invention will be described with reference to the drawings. FIGS. 1 to 8 relate to a first embodiment of the present invention. FIG. 1 is an exploded perspective view showing parts of a room lamp, FIG. 2 is a perspective view showing a switch provided with light emitting diodes, FIG. 3 is a plan view of the room lamp, FIG. 4 is a cross-sectional view of parts of the room lamp taken along the line IV-IV in FIG. 3, FIG. 5 is a cross-sectional view of parts of a modification of the room lamp shown in FIG. 4, FIG. 6 is a diagram showing a relative light emission intensity of the light emitting diode, FIG. 7 is a plan view of a map lamp, and FIG. 8 is a cross-sectional view of parts of the map lamp taken along the line IIX-IIX in FIG. 7.

In FIGS. 1, 3 and 4, reference numeral 1 denotes a room lamp (illuminating apparatus) attached to an interior ceiling of a vehicle. The room lamp 1 has a housing 2 that has a flat box like shape and has an open bottom. The housing 2 is an integrally molded resin component formed by injection molding and has a rectangular back plate 2a and side walls 2b standing from the sides of the back plate 2a, for example.

In the housing 2, a first group of contacts 5 to be electrically connected to a switch 10 described later is provided approximately at a center part of the back plate 2a, and a plurality of (four, for example) fitting holes 8 is punctured and formed around the first group of contacts 5. In addition, a second group of contacts 6 to be electrically connected to a light source unit 20 described later is provided in the vicinity of the first group of contacts 5. In addition, bus bars 7 to be appropriately electrically connected to the individual contacts of the first and second groups of contacts 5 and 6 are laid on the back plate 2a in such a manner that ends of the bus bars 7 face a connector insertion opening 2c formed in the side wall 2b. The first and second groups of contacts 5 and 6, the bus bars 7 and the like are formed by screen printing on the back plate 2a, for example.

In addition, a step part 2d on which an outer lens 30 that covers the opening of the housing 2 is fitted is formed in a lower end part of each side wall 2b.

The switch 10 has a switch main body 11 having an approximately rectangular column shape, for example. The switch main body 11 has, on a top surface thereof, a group of contacts (not shown) to be electrically connected to the first group of contacts 5 on the housing 2, and pins 12 to be fitted into the fitting holes 8 are provided around the group of contacts. Once the pins 12 are fitted into the fitting holes 8, the switch 10 is positioned on and fixed to the back plate 2a of the housing 2, and the individual contacts of the group of contacts provided on the switch 10 are electrically connected to the individual contacts of the first group of contacts 5.

In addition, the switch main body 11 has an elongated hole 13 formed in a lower surface thereof, and a switch control part 14 protrudes from the elongated hole 13. In the present embodiment, on the elongated hole 13 three sections are set that correspond to an “ON” position P1 to keep the room lamp 1 turned on, an “OFF” position P2 to keep the room lamp 1 turned off, and a “DOOR” position P3 to turn on the room lamp 1 depending on the open/closed state of a door of the vehicle. The switch control part 14 is a slidable control part and is slid to select any one of the positions P1 to P3.

The four corners of the switch main body 11 formed by the side walls are rounded to have a radius of 0.5 mm or more. In addition, the switch main body 11 has an outward flange 15 formed to surround the outer periphery of a lower part thereof.

The light source unit 20 essentially has an elongated band-like flexible substrate 21 having a length approximately equal to the outer periphery of the switch main body 11 and a plurality of light emitting diodes (LEDs) 22 serving as a light source mounted on the flexible substrate 21 at predetermined intervals. In addition, terminal pins 23 capable of being electrically connected to the individual contacts of the second group of contacts 6 are provided on the flexible substrate 21.

In the present embodiment, each LED 22 is a surface mount white LED that is an LED having a blue light emitting part, the surface of which is coated with a yellow phosphor (YAG phosphor, for example) to produce white light. A single-sided convex lens 22a is fixed onto a light emitting surface of each LED 22. The single-sided convex lens 22a serves to adjust the light emitted by the LED 22 to produce a relatively highly directional light flux having a narrow diffusion angle of about 15 degrees to 20 degrees with respect to a 0-degree axis (an optical axis O) as shown by the solid line in FIG. 6, for example.

As shown in FIG. 2, the light source unit 20 is held onto the switch 10 by bending the flexible substrate 21 around the outer periphery of the switch main body 11. The terminal pins 23 are electrically connected to the individual contacts of the second group of contacts 6 by pressure fitting, soldering, laser welding, caulking or the like when the switch 10 is positioned on and fixed to the back plate 2a of the housing 2. The LEDs 22 are held in the housing 2 with the aid of the switch 10, and the optical axis O of each LED 22 is directed approximately perpendicular to the side wall 2b. In other words, the peak of the radiation directivity of each LED 22 is directed approximately perpendicular to the side wall 2b.

Since the four corners of the switch main body 11 formed by the side walls are rounded, the flexible substrate 21 bent around the switch main body 11 is surely prevented from disconnecting due to bending or the like. Besides, in order to prevent direct exposure of the LEDs 22 held in the housing 2 to the outside of the housing 2, the length of protrusion of the outward flange 15 formed on the periphery of the switch 10 is preferably determined to hide the LEDs 22 from view from below the switch 10 as shown in FIGS. 2 and 3, for example.

The outer lens 30 is a flat plate member, the outer periphery of which is fitted on the step parts 2d of the housing 2. The outer lens 30 is formed of a transparent resin material by injection molding, for example, and has an elongated hole (opening) 31 corresponding to the elongated hole 13 in the switch 10 approximately at a center part thereof. In addition, a plurality of fine diffusion steps 32 is formed on an inner surface (the surface facing the back plate 2a) of the outer lens 30 in an annular region surrounding the elongated hole 31. A region of an outer surface of the outer lens 30 that corresponds to the region in which the diffusion steps 32 are formed serves as a light emitting surface 30a.

As shown in FIG. 4, the outer lens 30 is configured so that the inner surface abuts against the outer flange 15 when the outer periphery of the outer lens 30 is fitted on the step parts 2d. Thus, the switch 10 is held between the outer lens 30 and the back plate 2a. In addition, the switch control part 14 protruding from the switch main body 11 is exposed to the outside of the room lamp 1 through the elongated hole 31.

In addition, as shown in FIG. 4, a reflecting member 35 is disposed in a space surrounding the switch 10 in the housing 2. The reflecting member 35 is formed of a material having a reflectance of 90% or higher, such as polycarbonate and acryl containing titanium oxide, by injection molding, and a surface of the reflecting member 35 facing the LEDs 22 serves as a reflecting surface 35a. The reflecting member 35 reflects the light emitted by the LEDs 22 on the reflecting surface 35a to guide the light to the outer lens 30.

In this configuration, when a connector (not shown) extending from the vehicle is connected to the connector insertion opening 2c, and the switch control part 14 is switched to the “ON” position P1 or the “DOOR” position P3 to supply power to the flexible substrate 21 through the second group of contacts 6 to turn on the LEDs 22, most of the light emitted by the LEDs 22 is reflected by the reflecting surface 35a and then incident on the diffusion steps 32 of the outer lens 30. More specifically, according to the present embodiment, since the single-sided convex lenses 22a fixed to the light emitting surface of the LEDs 22 serve to narrow down the diffusion angle of the emission light, and the outward flange 15 is disposed below the LEDs 22, most of the light emitted by the LEDs 22 is not directly incident on the outer lens 30 but indirectly incident on the outer lens 30 after reflection from the reflecting surface 35a.

Since the light emitted by the LEDs 22 is indirectly incident on the outer lens 33 after reflection, problems, such as a local increase in brightness of the light emitting surface 30a at parts corresponding to the light emitting parts of the LEDs 22, can be reliably prevented. In addition, since the light incident on the outer lens 30 is diffused by the diffusion steps 32 in a predetermined manner, the light emitting surface 30a can provide light with more uniform illuminance. In addition, since most of the light emitted by the LEDs 22 is indirectly incident on the outer lens 30 via the reflecting surface 35a, dispersion of the blue light and yellow light forming the white light by the outer lens 30 can be prevented with reliability.

In addition, since the switch main body 11 is disposed on the side of the inner surface of the outer lens 30, and the switch control part 14 protruding from the switch main body 11 is exposed to the outside through the elongated hole 31 formed in the outer lens 30, the switch 10 can be disposed inside the light emitting surface 30a. In addition, since the light source unit 20 having the LEDs 22 mounted on the flexible substrate 21 is bent around the switch main body 11 in the housing 2, the optical axis O of each LED 22 can be readily directed to the side wall 2b (to the reflecting surface 35a). In addition, since the LEDs 22 can be disposed in such a manner that the optical axes O thereof are radially directed from the switch 10, occurrence of an extremely dark part on the light emitting surface 30a can be prevented with reliability.

The LEDs 22 serving as a light source of the room lamp 1 described above may be LEDs that emit light containing ultraviolet rays. In this case, the light emitting surface 30a can be made to emit white light in a more preferred manner by coating the reflecting surface 35a with a paint containing a phosphor that is excited by ultraviolet rays to emit excitation light having a color rendering index Ra of 90 or higher, for example. As an alternative to coating with a phosphor, the reflecting member 35 may be molded from a resin material or the like containing a phosphor so that a phosphor is distributed over the reflecting surface 35a.

In the case where the LEDs 22 serving as a light source of the room lamp 1 described above have a relatively wide diffusion angle of the emission light (as indicated by the dashed line in FIG. 6, for example), the amount and color of the emission light can be made uniform over the light emitting surface 30a as with the configuration described above if the switch main body 11 has tapered side surfaces and expands downward so that the peak of the radiation directivity (the optical axis O) of the light emitted by each LED 22 is inclined at a predetermined elevation angle with respect to a horizontal direction H as shown in FIG. 5, for example.

Furthermore, the slidable switch control part 14 can be replaced with a pair of push-type switch control part 17 as shown in FIGS. 7 and 8, for example. In this case, the push-type switch control part 17 protrudes from the switch main body 11, the power supply system for the LEDs 22 on the flexible substrate 21 is divided into two power supply systems associated with the switch control parts 17, and a partition wall 2e protrudes in the housing 2 to divide the light emitting surface 30a into regions corresponding to the LEDs 22 of the respective power supply systems. Thus, a map lamp 50 capable of separately illuminating a driver seat and a passenger seat can be provided.

In the embodiment described above, all the LEDs 22 used as a light source do not have to emit light of the same color. For example, a combination of LEDs that emit red (R) light, LEDs that emit green (G) light and LEDs that emit blue (B) light can be used at the same time. In this case, if the amount of light emission is controlled independently for the LEDs that emit light of different colors, a wide variety of illumination effects can be exhibited.

Furthermore, in the embodiment described above, the switch 10 is disposed approximately at a center part of the light emitting part 30a, as an example. However, the present invention is not limited to such an arrangement, and the switch 10 may be displaced in any direction on the light emitting surface 30a. In this case, the amount of light emission can be made uniform over the light emitting surface 30a by appropriately adjusting the intervals between the LEDs 22 mounted on the flexible substrate 21, for example.

Furthermore, in the embodiment described above, the reflecting member 35 may be a member integrated with the housing 2.

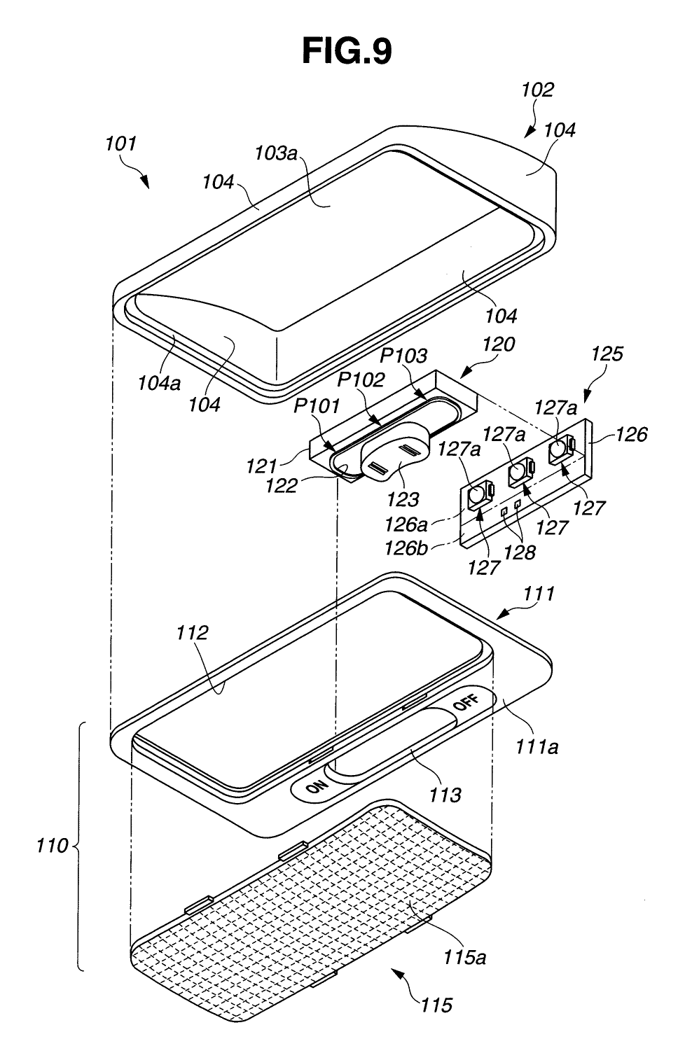

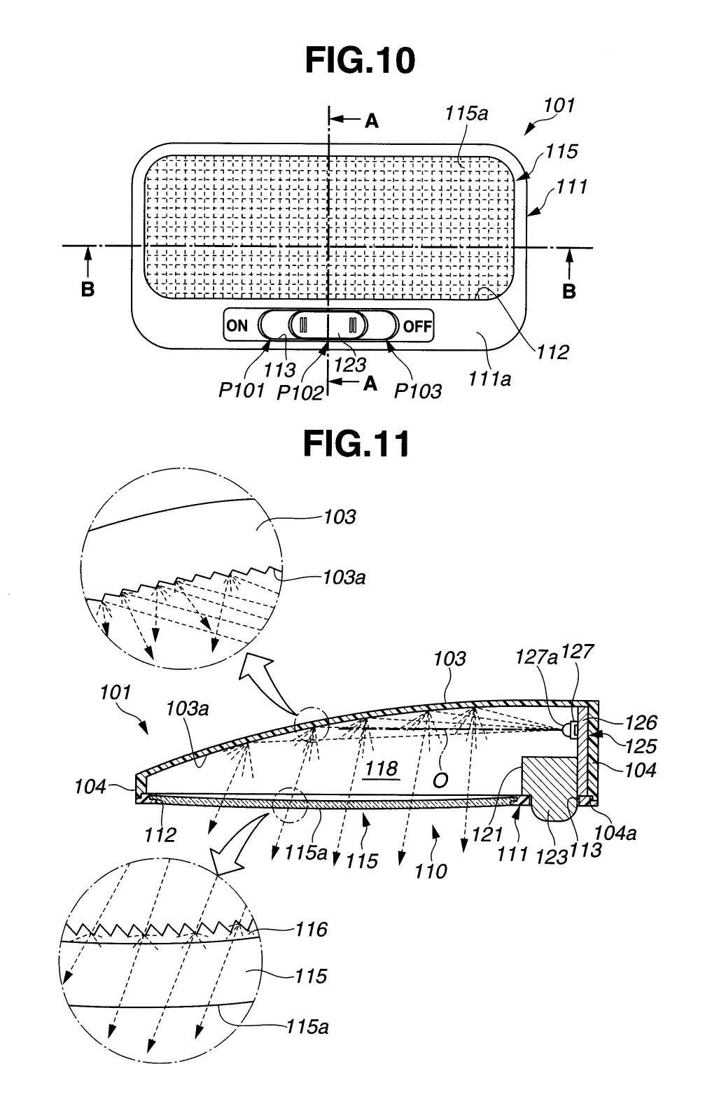

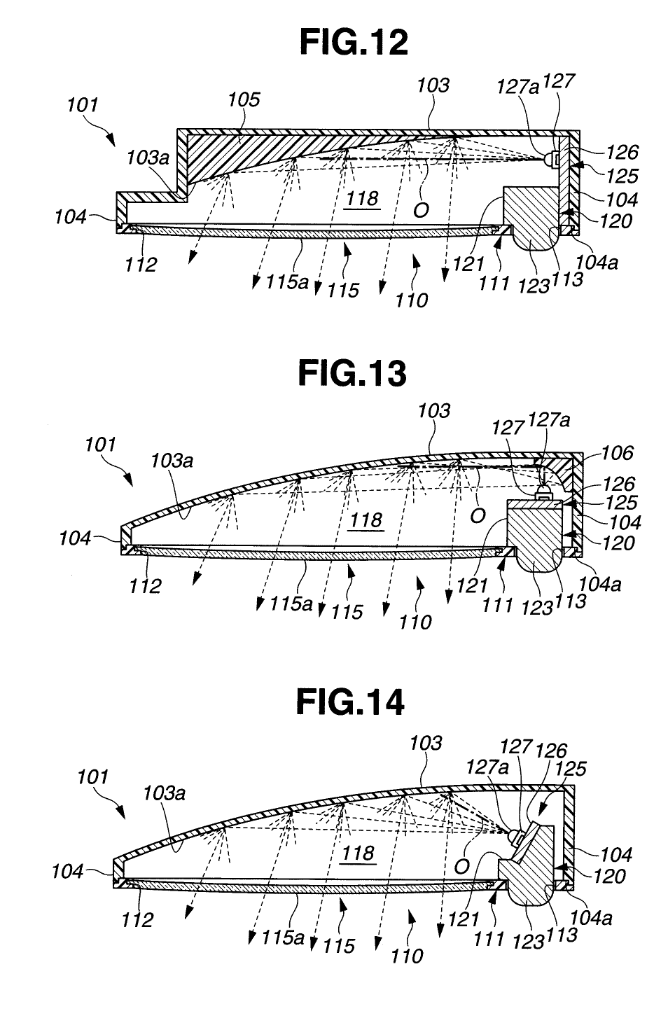

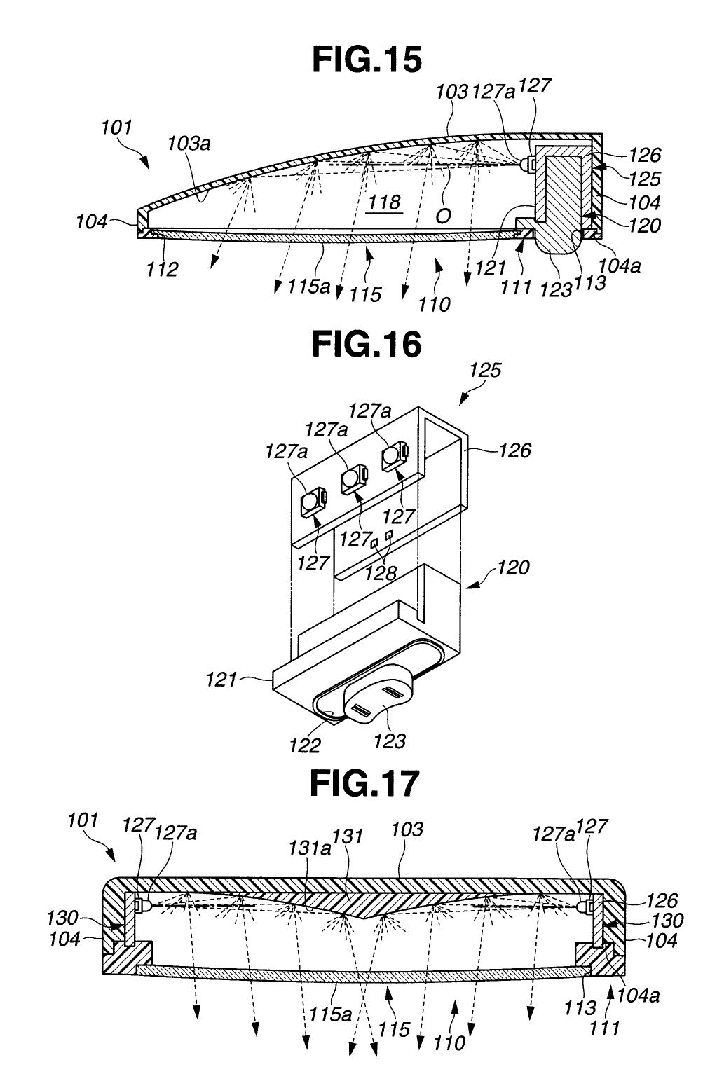

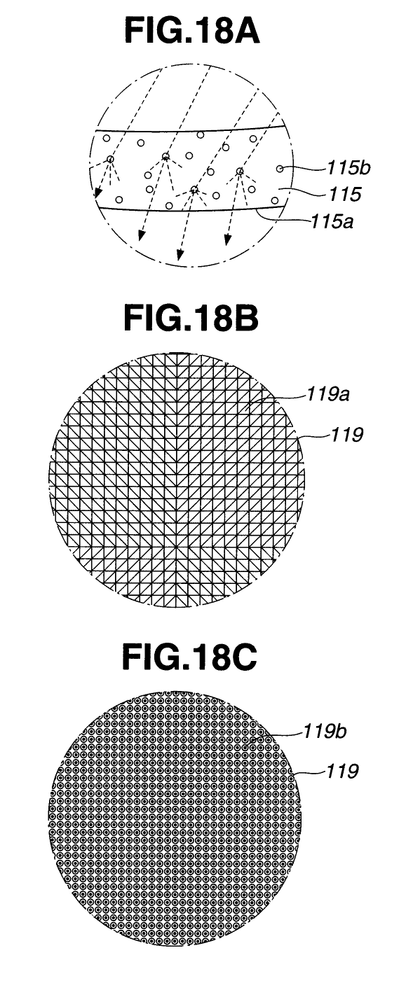

FIGS. 9 to 18C relate to a second embodiment of the present invention. FIG. 9 is an exploded perspective view showing parts of a room lamp, FIG. 10 is a plan view of the room lamp, FIG. 11 is a cross-sectional view of parts of the room lamp taken along the line A-A in FIG. 10, FIGS. 12 to 15 are cross-sectional views of parts of modifications of the room lamp taken along the line A-A in FIG. 9, FIG. 16 is an exploded perspective view showing a relationship between a switch mechanism and a light source unit shown in FIG. 15, FIG. 17 is a cross-sectional view of parts of a modification of the room lamp taken along the line B-B in FIG. 9, FIG. 18A is an enlarged cross-sectional view showing a modification of an outer lens, and FIGS. 18B and 18C are plan views showing the inside of the outer lens in an enlarged manner.

In FIGS. 9 to 11, reference numeral 101 denotes a room lamp (illuminating apparatus) attached to an interior ceiling of a vehicle. The room lamp 101 has a housing 102 that has a flat box like shape and has an open bottom. The housing 102 is an integrally molded resin component formed by injection molding and has an approximately rectangular back plate 103 and side walls 104 protruding downward from the sides of the back plate 103, for example.

More specifically, the housing 102 is molded from a highly reflective resin material, such as highly reflective polycarbonate. Thus, the back plate 103 serves as a reflecting member, and the inner surface (lower surface) of the back plate 103 is configured to serve as a reflecting surface 103a. Alternatively, the housing 102 may be molded from a metallic material, such as aluminum, instead of the highly reflective resin material. Alternatively, the housing 102 may be molded from a resin material other than the highly reflective resin material, and a sheet having a high reflectance may be applied onto the inner surface of the back plate 103. As an alternative to the sheet having a high reflectance, white or opaque white coating or vapor deposition may be applied onto the inner surface of the back plate 103, for example.

According to the present embodiment, as shown in FIG. 11, the back plate 103 is curved so that the reflecting surface 103a is gently inclined downward from one side to the other in the lateral direction. In addition, in order to provide efficient scattering of the reflection light, the reflecting surface 103a has fine irregularities formed thereon.

In addition, a step part 104a is formed at a lower end part of each side wall 104 of the housing 102, so as to fit an outer cover 110 which covers the opening of the housing 102.

The outer cover 110 has a frame body 111 fitted on the step parts 104a and an outer lens 115 fitted into the frame body 111.

The frame body 111 is a resin molding having a light blocking capability, for example. Of the four frame sections of the frame body 111 that define an outer lens fitting part 112, a frame section 111a located at one side of the frame body 111 in the lateral direction is wider than the other frame sections, so that the center of the outer lens 115 held by the frame body 111 is displaced from the center of the room lamp 101 toward the other side of the frame body 111 in the lateral direction. In addition, the wider frame section 111a has an elongated hole 113 for insertion of a switch control part 123 of a switch mechanism 120 described later formed along the outer lens fitting part 112.

The outer lens 115 is a resin molding having a translucency, for example. The outer lens 115 has a spherical shape that is slightly convex downward, and an outer surface (lower surface) of the outer lens 115 is configured to serve as a light emitting surface 115a.

On the other hand, in the housing 2, the inner surface of the outer lens 115 faces the reflecting surface 103a, and an air layer 118 is formed between the outer lens 115 and the reflecting surface 103a. In order that the outer lens 115 has a light diffusion capability, a diffusion sheet 116 having fine irregularities is applied to the back surface of the outer lens 115, for example (see FIG. 11).

The switch mechanism 120 has a switch main body 121 having an approximately rectangular cylindrical shape, for example. The switch main body 121 has an elongated hole 122 formed in a lower surface thereof, and the switch control part 123 protrudes from the elongated hole 122. In the present embodiment, on the elongated hole 122 three sections are set that correspond to an “ON” position P101 to keep the room lamp 101 turned on, a “DOOR” position P102 to turn on the room lamp 101 depending on the open/closed state of a door of the vehicle, and an “OFF” position P103 to keep the room lamp 101 turned off. The switch control part 123 is a slidable control part and is slid to select any one of the positions P101 to P103.

The switch mechanism 120 is held to the outer cover 110 by aligning the elongated holes 113 and 122 with each other and then fixing the lower surface of the switch main body 121 to the frame section 111a from inside. In so doing, the switch control part 123 is inserted into the elongated hole 113 and thus exposed to the outside of the outer cover 110.

Once the switch mechanism 120 is held to the outer cover 110, the switch main body 121 is positioned in the housing 102 to face one side wall 104 located at one side in the lateral direction at a predetermined distance. The switch main body 121 has a light source unit 125 held in the clearance between the switch main body 121 and the side wall 104.

The light source unit 125 has an LED substrate 126 having an approximately rectangular shape and serving as an element substrate. On one surface of the LED substrate 126, a light source mounting region 126a in which a light emitting diode (LED) 127 serving as a light emitting element is mounted and a terminal region 126b to be electrically connected to the switch mechanism 120. The LED substrate 126 is preferably made of a material having a high thermal conductivity, such as aluminum.

In the light source mounting region 126a, a plurality of (three, for example) LEDs 127 is mounted by soldering or the like. In the present embodiment, each LED 127 is a surface mount white LED that is an element having a blue light emitting part, the surface of which is coated with a yellow phosphor (YAG phosphor, for example) to produce white light. A single-sided convex lens 127a is fixed to a light emitting surface of each LED 127. The single-sided convex lens 127a serves to adjust the light emitted by the LED 127 to produce a relatively highly directional light flux having a narrow diffusion angle of about 15 degrees to 20 degrees with respect to a 0-degree axis (an optical axis O), for example.

On the other hand, a plurality of terminals 128, which are to be electrically connected to the LEDs 127 by wiring or the like (not shown), are provided in the terminal region 126b. The terminal region 126b is configured to be fixed to a surface of the switch main body 121 that faces the side wall 104 on one side in the lateral direction of the housing 102, and thus, each terminal 128 is directly electrically connected to the switch mechanism 120 without interposition of a bus bar or the like.

In addition, since the terminal region 126b is fixed to the switch main body 121, the light source unit 125 is held to the switch mechanism 120 in such a manner that each LED 127 protrudes above the switch main body 121, and the optical axis O of each LED 127 is directed to the reflecting surface 103a. That is, the optical axis O of each LED 127 extends substantially horizontally in the housing 102 from one side to the other side in the lateral direction and is directed in the housing 102 to the reflecting surface 103a that is curved downward.

The LEDs 127 are located above the switch main body 121 in the housing 102 and therefore cannot be visually recognized when the outer lens 115 is viewed straight from the front. In other words, the LEDs 127 are disposed at positions where the LEDs are hidden by the switch mechanism 120 (and the frame body 111) disposed around the outer lens 115 and cannot be visually recognized.

In this configuration, when the switch control part 123 is switched to the “ON” position P101 or the “DOOR” position P102 to supply power to the light source unit 125 through the switch mechanism 120 to turn on the LEDs 127, most of the light emitted by the LEDs 127 is reflected by the reflecting surface 103a and then guided to the outer lens 115 through the air layer 118 as shown in FIG. 11. More specifically, according to the present embodiment, since the single-sided convex lenses 127a fixed to the light emitting surface of the LEDs 127 serve to narrow down the diffusion angle of the emission light, and the switch main body 121 and the frame section 111a are disposed below the LEDs 127, most of the light emitted by the LEDs 127 is not directly incident on the outer lens 115 but indirectly incident on the outer lens 115 after reflection from the reflecting surface 103a.

Since the LEDs 127 emit light in the vicinity of the reflecting surface 103a where the LEDs 127 are hidden by the switch main body 121 and the frame section 111a, and the light emitted by the LEDs 127 is indirectly incident on the outer lens 115 after reflection from the reflecting surface 103a, problems, such as a local increase in brightness of the light emitting surface 115a, can be reliably prevented with a simple configuration. That is, the switch mechanism 120 (and the frame section 111a having a larger width in order to accommodate the switch mechanism 120) is advantageously used to hide the LEDs 127 in the housing 2 from view through the outer lens 115, thereby reliably preventing occurrence of glare or the like on the light emitting surface 115a with a simple configuration.

In this case, since the light emitted by each of LEDs 127 is diffused by the fine irregularities formed on the reflecting surface 103a and the diffusion sheet 116 applied to the outer lens 115, the light emitting surface 115a can provide light with more uniform illuminance.

In addition, since the reflecting surface 103a is curved so that the reflecting surface 103a has a decreased distance to the outer lens 115 as the reflecting surface 103a is distant from the LEDs 127, the reflection light can be efficiently incident on the outer lens 115 even in a region far from the light source unit 125, so that the light emitting surface 115a can provide light with more uniform illuminance.

In addition, since the LED substrate 126 is made of a material having a high thermal conductivity, the heat radiation characteristics of the light source unit 125 can be improved, and high light emission efficiency of each of LEDs 127 can be maintained.

As shown in FIG. 12, for example, in the room lamp 101, the reflecting surface 103a may be formed by a reflecting member 105 separate from the housing 102. With this configuration, the shape or the like of the reflecting surface 103a can be readily changed depending on the specifications of the light source unit 125 or the like without significantly modifying the housing 102.

Furthermore, as shown in FIG. 13, for example, in the room lamp 101, the light source unit 125 may be fixed to the upper surface of the switch main body 121. In this case, although the optical axis O of each LED 127 is directed upward, another reflecting member 106 can be provided at a position to face the LEDs 127 to indirectly direct the optical axis O to the reflecting surface 103a. With this configuration, although not shown, the terminal region is formed on different surfaces of the LED substrate 126 from the light source mounting region. With this configuration, the LEDs 127 are disposed in the housing 102 at positions where the LEDs 127 are more effectively hidden from view through the outer lens 115.

Furthermore, as shown in FIG. 14, for example, the switch main body 121 may have an inclined top surface, and the light source unit 125 may be fixed to the inclined surface. With this configuration, the optical axis O of each LED 127 can be directed to the reflecting surface 103a at any angle depending on the angle of the inclined surface, and thus, the orientation characteristics can be more readily tuned, for example.

Furthermore, as shown in FIGS. 15 and 16, for example, in the room lamp 101, the LED substrate 126 may be made of a metallic material having a high thermal conductivity, such as aluminum, and bent several times to conform to the shape of the switch main body 121 of the switch mechanism 120. With this configuration, the heat radiation capability of the LED substrate 126 can be greatly improved without excessively increasing the installation space for the LED substrate 126 in the housing 102.

Furthermore, as shown in FIG. 18A, for example, in the room lamp 101, the outer lens 115 may be molded from a transparent resin material containing a diffusion material 115b, instead of applying the diffusion sheet 116 or the like to the outer lens 115. Alternatively, for example, as shown in FIGS. 18B and 18C, a prism pattern 119a, a cylinder pattern 119b or the like may be formed on the inner surface of the outer lens 115.

In the configurations according to the embodiment described above, the light source unit is disposed in the housing 2 at one side in the lateral direction. However, for example, as shown in FIG. 17, light source units 130 may be disposed in the housing 102 at the sides in the longitudinal direction where the switch mechanism 120 is not disposed. In this case, if a reflecting member 131 that has a reflecting surface 131a having a predetermined shape determined by the arrangement of the light source units 130 is provided in the housing 102, the light emitting surface 115a can provide light with high uniformity ratio of illumination.

In the embodiment described above, the plurality of LEDs 127 forming the light source unit emit light of the same color. However, the present invention is not limited to the configuration. For example, the light source unit may be formed by a combination of a plurality of types of LEDs that emit light of different colors (LEDs that emit R, G and B light, for example). With this configuration, color of the light provided from the light emitting surface 115a can be arbitrarily changed, and thus, the color rendering can be improved.

The application of the present invention is not limited to a room lamp, and the present invention can be applied to other various illuminating apparatuses.

1-9. (canceled)

10. An illuminating apparatus, comprising:
an outer lens having an outer surface forming a light emitting surface;
a reflecting member having a reflecting surface facing an inner surface of the outer lens;
a light source unit having a light emitting element arranged in such a manner that an optical axis thereof is directed to the reflecting surface; and
a switch mechanism disposed adjacent to the outer lens,
wherein the light source unit is held to the switch mechanism at a position where the light source unit is hidden by the switch mechanism.

11. The illuminating apparatus according to claim 10, wherein an air layer is formed between the outer lens and the reflecting member.

12. The illuminating apparatus according to claim 10, wherein the light source unit has an element substrate having a high thermal conductivity on which the light emitting element is mounted, and
the element substrate is bent to conform to the shape of the switch mechanism.

13. The illuminating apparatus according to claim 10, wherein the light source unit has a plurality of light emitting elements which emit light of different colors.

14. The illuminating apparatus according to claim 10, wherein the reflecting surface is configured to have a decreased distance to the outer lens as it is distant from the light emitting element.

15. The illuminating apparatus according to claim 10, wherein the light source unit further has a flexible substrate that has the light emitting element mounted thereon and that is bent around a periphery of the switch mechanism.

16. The illuminating apparatus according to claim 10, wherein the emitted light from the light emitting element contains ultraviolet rays, and
the reflecting surface is provided with a phosphor which is excited to emit light by ultraviolet rays.
